(19) United States
(12) Patent Application Publication
(10) Pub. No.: US 2021/0348960 A1
(43) Pub. Date: Nov. 11, 2021

(54) CAPACITIVE POINT LEVEL SENSOR

(71) Applicant: Computime Ltd., New Territories (HK)

(72) Inventor: Kam Tim Cheung, Hong Kong (CN)

(21) Appl. No.: 16/866,645

(22) Filed: May 5, 2020

(51) Int. Cl. G01F 23/26; G08B 21/18

(52) U.S. Cl. CPC G01F 23/265; G08B 21/182; G01F 23/266

(57) ABSTRACT

The present invention is directed to a capacitive sensor that has electrodes externally positioned on or proximate to the surface of a non-metallic container for detecting a usage level inside the container, where the contents may be liquid or granular solids. By generating an excitation signal to the electrodes and processing the resulting signal waveform, the usage level may be detected with respect to the position of the electrodes. Consequently, embodiments provide a marker that is indicative of usage conditions such as a refill condition or an empty condition in order to inform the user to purchase a refill of the contents. Embodiments may operate with an Internet of Things device so that physical goods may be automatically ordered when the contents are at or below a predetermined level. Embodiments may provide a low cost design and may be used in many applications, such as an oil diffuser.

### TECHNICAL FIELD

Aspects of the disclosure relate to determining a usage level of contents in a container using a capacitive sensor.

### BACKGROUND OF THE INVENTION

There are applications for dispensing contents stored within a container. However, the level of the contents may not be readily visible to the user, and thus the user may not readily know when the contents needs to be refilled. Corresponding applications are numerous including essential oil diffusers, fragrant oil diffusers, air freshener dispensers, air odor eliminators, sprayers, automatic hand sanitizers, mist humidifiers, water dispensers, and coffee machines. However, traditional approaches often rely on sensors being immersed into the contents within the container. Consequently, there is a real market need to provide a non-obtrusive approach to determining a usage level of contents within a container.

### SUMMARY OF THE INVENTION

The present invention provides methods and apparatuses for determining a contents level inside a non-metallic container by using a variation of the capacitance between sense electrodes that are externally located to the container. Container contents may include a variety of liquids or granular solids including, but not limited to, hand cleaners, fragrant oils, water, coffee, and the like. In addition, the container may be constructed from a variety of materials including, but not limited to, plastic, cardboard, glass, and so forth.

With an aspect of the embodiments, an apparatus determines a usage level of container contents in a non-metallic container. A capacitive sensor includes a pair of electrodes that comprises a first electrode and a second electrode and is externally positioned on or proximate to a surface of the non-metallic container at a point level. A signal generator generates an excitation signal to charge an equivalent capacitor associated with the capacitive sensor at a pre-defined amount of charge, and a signal receiver subsequently measures the voltage across the capacitor. A processing circuit determines whether the usage level of the contents is below the point level of the electrode pair. With another aspect, an excitation signal charges an equivalent capacitor of a capacitive sensor with a pre-defined amplitude of voltage, and a signal receiver measures the charge stored in the capacitor.

With another aspect, an excitation signal charges an equivalent capacitor of a capacitive sensor. The voltage across the capacitor is then measured at an appropriate time while the capacitor is discharging.

With another aspect, an apparatus has a plurality of electrode pairs positioned along a container, where each electrode pair corresponds to different point levels. Measurements are obtained from each selected electrode pair and processed to determine the usage level of the container contents.

With another aspect, a measuring circuit is electrically connected to a capacitive sensor in one of two ways. First, the capacitive sensor may assume a one-port typology, where one of the electrodes of an electrode pair is grounded while the measuring circuit is connected to the other electrode. Second, the capacitive sensor may assume a two-port typology, where the driver of the measuring circuit is connected to the first port and an analog to digital converter (ADC) is connected to the other port.

With another aspect, an apparatus includes a reporting circuit that generates an alert notification and/or ordering request when the usage level of container contents is below an alert level.

With another aspect, a capacitive sensor comprises M electrode pairs positioned in decreasing point positions along the non-metallic container. A processing circuit selects a next electrode pair through an electrode selector until the usage level is below an associated point position of the selected electrode pair.

### BRIEF DESCRIPTION OF THE DRAWINGS

The foregoing summary of the invention, as well as the following detailed description of exemplary embodiments of the invention, is better understood when read in conjunction with the accompanying drawings, which are included by way of example, and not by way of limitation with regard to the claimed invention.

FIG. 1 shows a container with a pair of sense electrodes for determining a usage level in accordance with an embodiment.

FIG. 2 shows an equivalent circuit with a first connection type for the sense electrodes shown in FIG. 1 in accordance with an embodiment.

FIG. 3 shows an equivalent circuit with a second connection type for the sense electrodes shown in FIG. 1 in accordance with an embodiment.

FIG. 4 shows a measuring circuit interacting with the sense electrodes shown in FIG. 1 via a first connection type in accordance with an embodiment.

FIG. 5 shows a measuring circuit interacting with sense electrodes shown in FIG. 1 via a second connection type in accordance with an embodiment.

FIGS. 6A and 6B show an exemplary driving waveform applied to sense electrodes shown in FIG. 1 in accordance with an embodiment.

FIGS. 6C-E shows exemplary waveforms from sense electrodes in response to the driving waveform shown in FIG. 6A-B in accordance with an embodiment.

FIG. 7 shows an apparatus for determining a usage level of the container shown in FIG. 1 in accordance with an embodiment.

FIG. 8 shows a computing system supporting the apparatus shown in FIG. 7 in accordance with an embodiment.

FIG. 9 shows a process for determining a usage level of the container shown in FIG. 1 in accordance with an embodiment.

FIG. 10 shows a container with a plurality of sense electrode pairs for determining a usage level in accordance with an embodiment.

FIG. 11 shows an apparatus for determining a usage level of the container shown in FIG. 10 in accordance with an embodiment.

FIG. 12 shows a process for determining a usage level of the container shown in FIG. 10 in accordance with an embodiment.

FIG. 13 shows a process for installing a container, monitoring contents of the container, and alerting a user as necessary in accordance with an embodiment.

### DETAILED DESCRIPTION

An apparatus with a capacitive sensor with one or more pairs of electrodes externally positioned on or proximate to a surface of a non-metallic container non-intrusively detects the level of the contents (for example, a liquid or granular solids) inside the non-metallic container. The apparatus supports one or more markers that are indicative of an usage condition, refill condition, or empty condition.

The apparatus can further notify a user to obtain/purchase a refill when the level is at or below a predetermined alert level. For example, the apparatus may operate with an Internet of Things (IoT) device and may automatically order more container contents in conjunction with the IoT device at the appropriate time. Embodiments support a variety of applications including, but not limited to, essential oil diffusers, fragrant oil diffusers, air freshener dispensers, air odor eliminators, sprayers for weed killers herbicides and insecticides, automatic hand sanitizers, mist humidifiers, water dispensers, and coffee machines.

Embodiments may provide advantages with respect to traditional approaches including low cost, simple implementation, broad application range, and non-intrusiveness that does not affect or alter the property of the material (container contents) being measured.

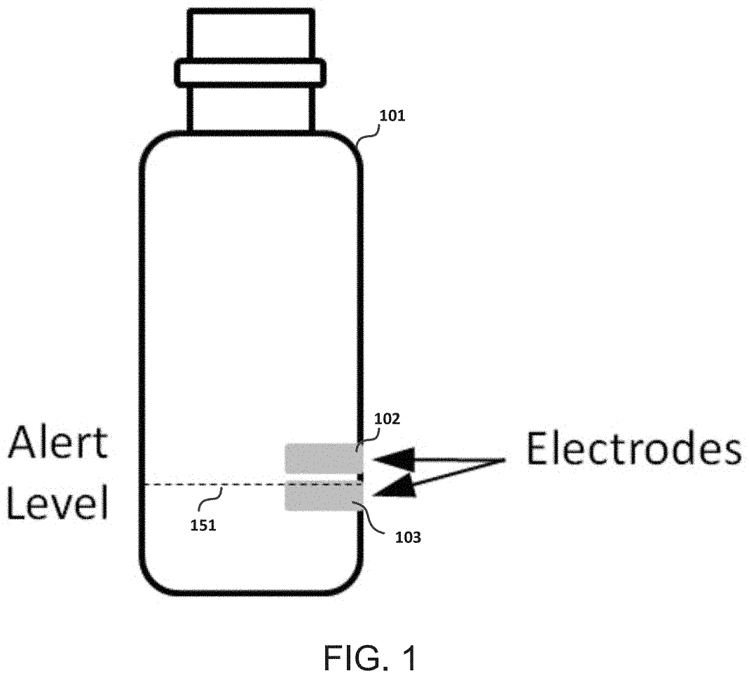

FIG. 1 shows non-metallic container 101 with a pair of sense electrodes 102 and 103 for determining a usage level 151.

Electrodes 102 and 103 may be on or proximate to a surface of non-metallic container 101. While embodiments support applications with non-metallic containers, non-metallic container 101 may be comprised of a variety of materials including, but not limited to, plastic, cardboard, glass, and so forth. Moreover, the container contents may comprise a variety of liquids or granular solids including, but not limited to, hand cleaners, fragrant oils, water, coffee, and the like.

With an aspect of the embodiments, the determination a usage level of the container contents is based on a measured change of capacitance. Each pair of electrodes (for example electrodes 102 and 103) are positioned adjacent to a corresponding measuring point level (for example, alert level 151) as shown in FIG. 1. While not explicitly shown, electrodes 102 and 103 are electrically connected to a measuring circuit as will be discussed in further detail.

An equivalent capacitance is dependent upon whether the contents is above or below alert level 151. In general the equivalent capacitance (as measured in relation to electrodes 102 and 103) is higher when the container contents is above alert level 151 than when below. The capacitor may be modeled with electrodes 102 and 103 and an equivalent dielectric layer based on the electrical characteristics of the container contents and container material. For example, the value of the capacitance may depend on the dielectric constant of the material filled inside container 101 (where the dielectric constant of the container contents is typically greater than 1), area of the electrodes 102 and 103, and the gap between electrodes 102 and 103. Consequently, the equivalent capacitance is dependent on the type of container contents as well as on the material of container 101 and may be determined through experiment or by electrical analysis.

Electrodes 102 and 103 may be positioned close (for example, within 0.3 millimeters) to or even on the surface of container 101. For example, electrodes 102 and 103 may be printed on container 101 or held into position by a fixture or product casing.

Embodiments may support applications with different containers. For example, container 101 may have different shapes and capacities (typically 20 ml or more). Container 101 may support a variety of applications from small dispensers to large storage containers. Depending on the desired equivalent capacitance and size/shape of container 101, electrodes 101 and 103 may assume different dimensions, for example, where the length, width, and thickness are 10 mm, 3 mm, and 0.2 mm, respectively.

The equivalent capacitance changes when the container contents is above or below a point level for a corresponding pair of electrodes. For example, the equivalent capacitance of a plastic container may be about 3 pF when the essential oil (the container contents) is above the point level and about 2 pF when the essential oil is below the point level.

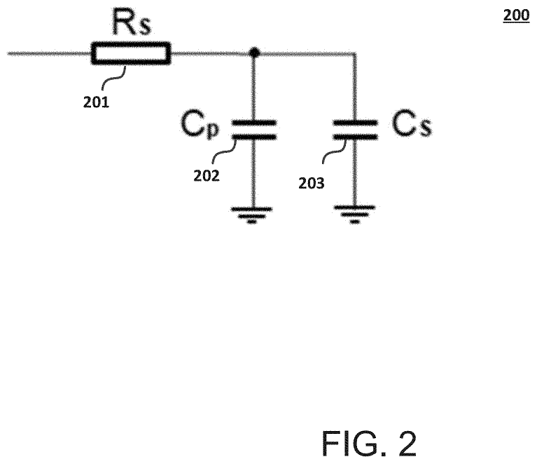

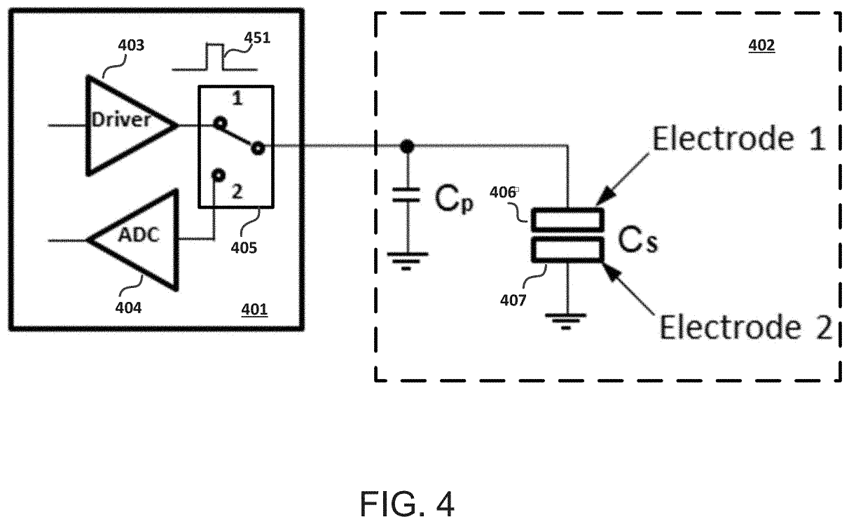

FIG. 2 shows equivalent circuit 200 of a modeled capacitor with a first connection type (type 1) for electrodes 102 and 103 as shown in FIG. 1. With circuit 200, electrode 102 is electrically connected to a measuring circuit (for example, circuit 401 as shown in FIG. 4) while electrode 103 (as shown in FIG. 1) is connected to electrical ground. Consequently, circuit 200 is modeled as a one-port circuit.

With a type 1 connection, a measuring circuit measures a self-capacitance, where one electrode (for example, electrode 103) is connected to ground and one electrode (for example, electrode 102) is connected to a driving and measuring path of a capacitance measuring circuit (for example, circuit 401 as shown in FIG. 4). The capacitance measuring circuit drives (excites) electrode 102 to charge up the equivalent capacitor formed by the two electrodes 102 and 103, and then measures the capacitance difference with or without the liquid or granular solids between the two electrodes 102 and 103. Based on the measured capacitance, it is determined whether or not the level of the container contents is above or below the position (which may be referred to the as the point level) of electrodes 102 and 103.

Referring to circuit 200, Rₛ 201 is the equivalent resistance from the measuring circuit to electrode 102, Cₚ 202 is the parasitic capacitance between the connecting path from the measuring circuit to electrode 102 and electrical ground, and Cₛ 203 is the capacitance between electrode 102 and electrode 103.

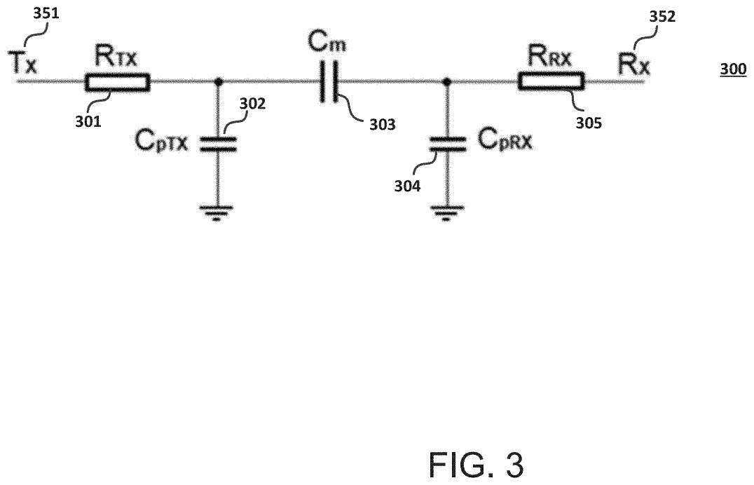

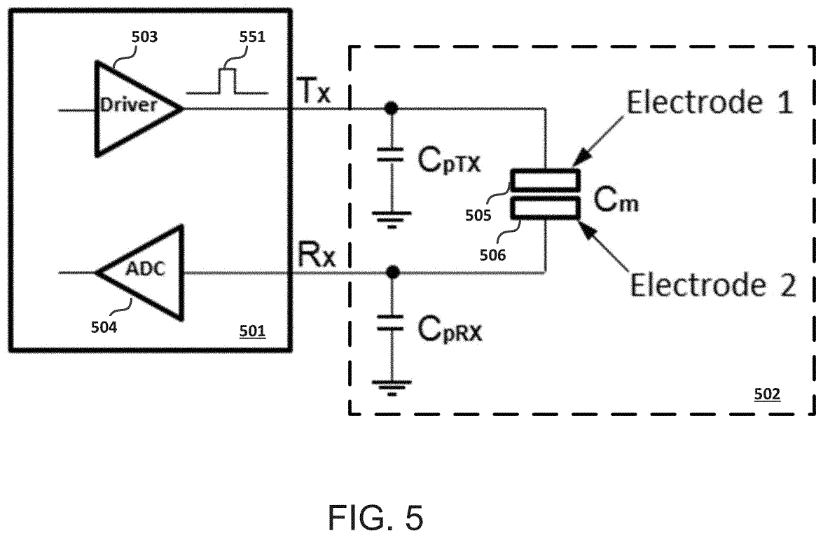

FIG. 3 shows an equivalent circuit with a second connection type (type 2) for electrodes 102 and 103 as shown in FIG. 1. With circuit 300, electrode 102 is connected to driver 503 of measuring circuit 501 as shown in FIG. 5 while electrode 103 is connected to ADC 504 of measuring circuit 501. Consequently circuit 300 is modeled as a two-port circuit.

With a type 2 connection, a measuring circuit measures the mutual capacitance, where one electrode (for example, electrode 102) is connected to transmit path and one electrode (for example, electrode 103) is connected to receive path of measuring circuit 501 as shown in FIG. 5. The measuring circuit charges up the capacitor through its transmit path, and then measures the capacitance difference with or without the liquid or granular solids by collecting the charge from the capacitor through its receive path.

Referring to circuit 300, Tx 351 is the transmit path of the capacitance measuring circuit, Rx 352 is the receive path of the capacitance measuring circuit, R_{TX} 301 is the equivalent resistance from the transmit path to electrode 102, R_{Rx} 305 is the resistance from the receive path to electrode 103, C_{pTx} 302 is the parasitic capacitance between the transmit path and electrode 102, C_{pRx} 304 is the parasitic capacitance between the receive path and electrode 103, and Cm 303 is the capacitance between electrodes 102 and 103.

FIG. 4 shows measuring circuit 401 interacting with the sense electrodes 406 and 407 (corresponding to electrodes 102 and 103 as shown in FIG. 1) via a type 1 connection (which is based on a one-port circuit typology). Capacitance measuring circuit 401 comprises driver 403, analog to digital converter (ADC) 404, and electrical switch 405. ADC 404 may be a simple voltage to a computer readable value conversion circuit. With some embodiments, ADC 404 may include a charge amplifier that produces a voltage output proportional to the charge from the electrodes and then converts it into a computer readable value. With some embodiments, ADC 404 may comprise an oscillator that oscillates at a frequency determined by the capacitance formed by the electrodes. A frequency counter then counts the frequency to obtain a computer readable value that is indicative of the capacitance formed by the electrodes with or without liquid or granular solids between the electrodes.

Driver 403 charges up (corresponding to charge or voltage waveform (pulse) 451) equivalent capacitor 402 formed by electrode 406 and electrode 407 through switch 405. Capacitor 402 is then connected to the receive path via switch 405 so that ADC 404 can measure the voltage across capacitor 402 or the charge on capacitor 402. When the level of the container contents is above the corresponding point level (in other words, there is liquid or granular solids inside the container between the electrodes 406 and 407, the relative permittivity is larger than that without the liquid or granular solids. The capacitance is smaller when there is no liquid or granular solids inside the container between electrodes 406 and 407 (in other words, the container contents is below the point level).

As will be discussed in greater detail, the voltage across capacitor 402 will be different as capacitor 402 charges and discharges when the level of the container contents is above or below the point level since the equivalent capacitance is correspondingly different.

FIG. 5 shows measuring circuit 501 interacting with sense electrodes 505 and 506 (corresponding to electrodes 102 and 103 as shown in FIG. 1) via a type 2 connection (which is based on a two-port circuit typology). Capacitance measuring circuit 501 comprises driver 503 and analog to digital converter (ADC) 504.

Driver 503 charges up (corresponding to charge or voltage waveform 551) equivalent capacitor 502 formed by electrode 505 and electrode 506 through the first port. ADC 504 then measures the charge or voltage across capacitor 502, which is indicative of the capacitance of capacitor 502. ADC 504 may be a simple voltage to a computer readable value conversion circuit. With some embodiments, ADC 504 may include a charge amplifier that produces a voltage output proportional to the charge from the electrodes and then converts it into a computer readable value. With some embodiments, ADC 504 may comprise an oscillator that oscillates at a frequency determined by the capacitance formed by the electrodes. A frequency counter then counts the frequency to obtain a computer readable value that is indicative of the capacitance formed by the electrodes with or without liquid or granular solids between the electrodes.

When the level of the container contents is above the corresponding point level (in other words, there is liquid or granular solids inside the container between the electrodes 505 and 506), the relative permittivity is larger than that without the liquid or granular solids. The capacitance is smaller when there is no liquid or granular solids inside the container between electrodes 505 and 506 (in other words, the container contents is below the point level).

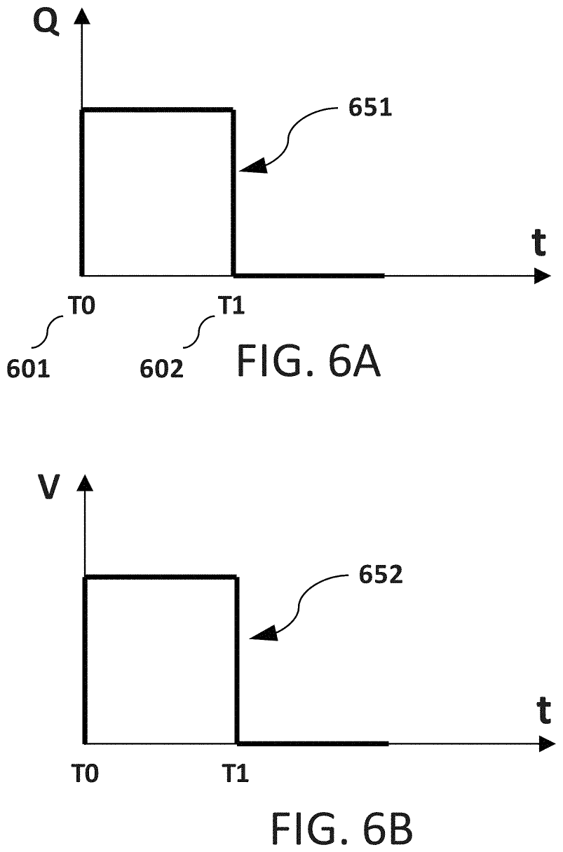

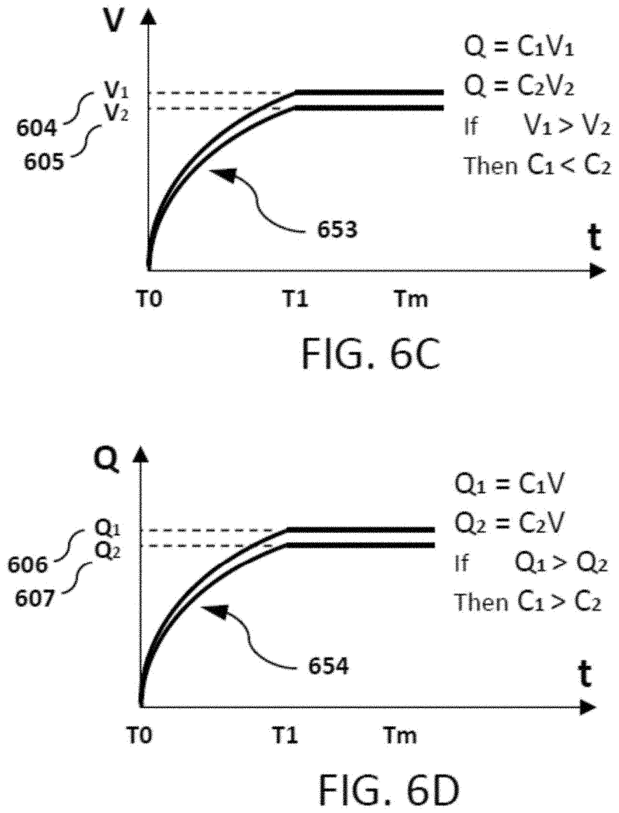

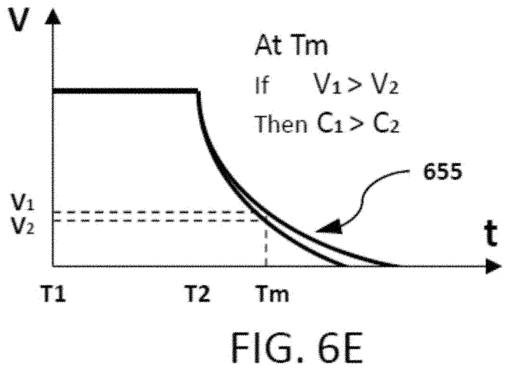

FIG. 6A shows driving (excitation) charge waveform 651, and FIG. 6B shows driving (excitation) voltage waveform 652 (corresponding to waveforms 451 and 551 as shown in FIGS. 4 and 5, respectively) applied to electrodes 102 and 103 as shown in FIG. 1. While waveform 651 or 652 is shown as a pulse from T₀ 601 to T₁ 602, embodiments may support other types of waveforms with different characteristics (for example, shape). During the time duration between T₀ and T₁, waveform excitation waveform charges capacitor 402 (with a type 1 connection) or capacitor 502 (with a type 2 connection). When waveform 651 or 652 terminates at T₁ 602, capacitor 402 or capacitor 502 starts to discharge at T₂.

FIGS. 6C-E shows exemplary voltage and charge waveforms 653, 654, and 655, respectively, from sense electrodes 102 and 103 in response to driving waveform 651 or 652. However, waveforms 653, 654, and 655 correspond to the container contents below (corresponding to a lower equivalent capacitance) and above the point level, respectively.

Measuring circuit 401 (for a type 1 connection) and measuring circuit 501 (for a type 2 connection) measures the charge or voltage across capacitors 402 and 502, respectively. As shown in FIG. 6, measuring circuit 401, 501 measures the voltage or charge at Tₘ, where the measured voltage is V₁ 604 for waveform 653 or the measured charge Q2 607 for waveform 654 (when the container contents is below the point level) and V₂ 605 for waveform 653 or Q₁ 606 for waveform 654 (when the container contents is above the point level). In general, the measured capacitance at Tₘ is smaller when the container contents is below the point level and is larger when the container contents is above the point level.

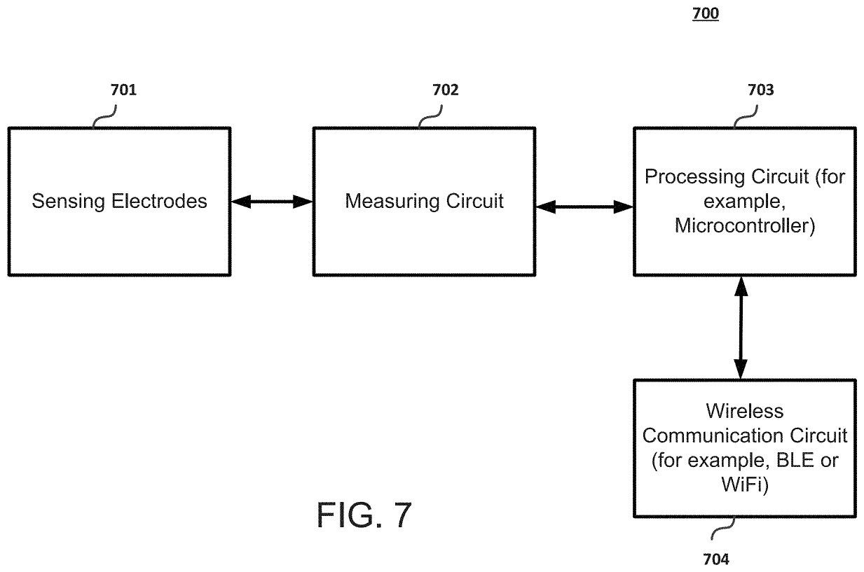

As will be discussed in further detail, apparatus 700 (shown in FIG. 7) uses the measured voltage (V₁ or V₂) or charge (Q₁ or Q₂) at Tₘ to determine the usage level for container 101.

While embodiments may measure the charge or voltage across capacitors 402 or 502 after charging, some embodiments may measure the charge or voltage while charging or discharging.

FIG. 7 shows apparatus 700 for determining a usage level of container 101 as shown in FIG. 1. Apparatus 700 comprises sensing electrodes 701 (for example, electrodes 102 and 103, 406 and 407, or 505 and 506 as shown in FIGS. 1, 4, and 5, respectively), measuring circuit 702 (for example, measuring circuits 401 or 501), processing circuit 703, and wireless communication circuit 704.

As previously discussed, measuring circuit 702 provides the value of the charge or voltage across the equivalent capacitor that models sensing sensors 701. Processing circuit 703 (for example, that may be implemented with a microcontroller) determines whether the container contents is above or below the point level based on the capacitance information provided by measuring circuit 702. For example, referring to FIG. 6, processing circuit 703 may determine that the usage level is above the point level when the measured voltage is within a first voltage range centered about V₂ 605 and is below the point level when the measured voltage level is within a second voltage range centered about V₁ 604.

With some embodiments, processing circuit 703 may initiate a notification via wireless communication circuit 704 (for example, supporting a Bluetooth Low Energy (BLE) or a WiFi communication channel) to inform a user about the determined usage level. When the usage level is below a level that is below an alert level, the notification may further generate an order for container contents to replenish the container.

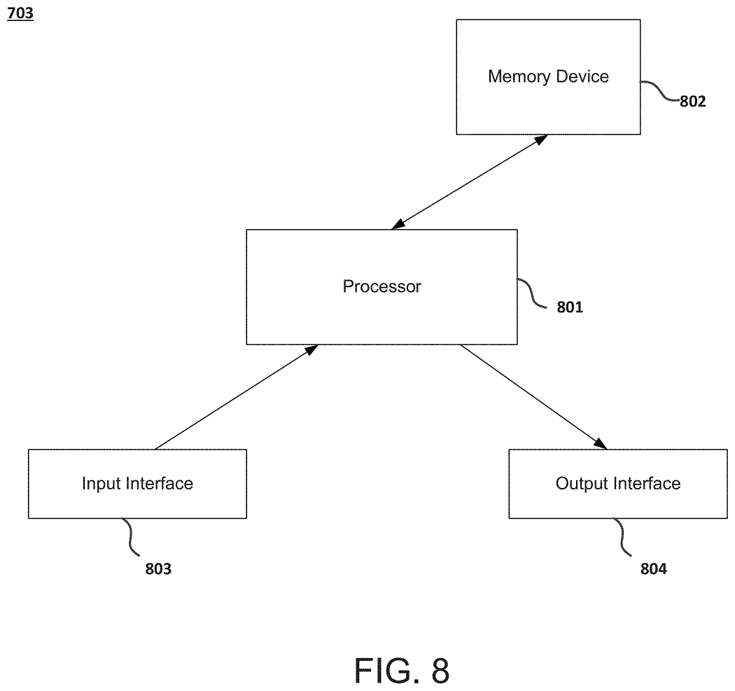

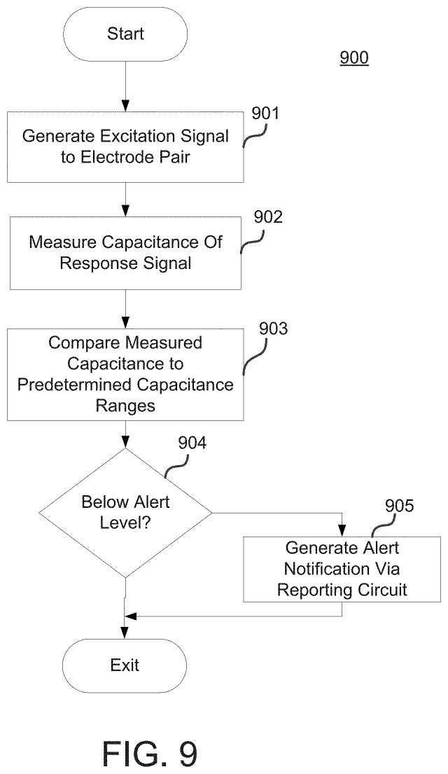

FIG. 8 shows computing system 703 (corresponding to processing circuit 703 as shown in FIG. 7) within apparatus 700. Processor 801 controls operation of apparatus 700 by executing computer readable instructions stored on memory device 802. For example, processor 801 may execute computer readable instructions to perform process 900 as will be discussed with FIG. 9. Embodiments may support a variety of computer readable media that may be any available media accessed by processor 801 and include both volatile and nonvolatile media, removable and non-removable media. By way of example, and not limitation, computer readable media may comprise a combination of computer storage media and communication media.

Computing system 703 may include input interface 803 to obtain voltage information from measuring circuit 702 and output interface 804 to initiate a measurement by measuring circuit 702.

Computer storage media may include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by the computing device.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Processing circuit 703 may be implemented in a number of ways. For example, processing circuitry 703 may be implemented with a microcontroller that typically includes a central processing unit (CPU), in addition with a fixed amount of RAM, ROM and other peripherals all embedded on a single chip. However, processing circuitry may be implemented with a plurality of integrated circuits and/or discrete electronic components.

FIG. 9 shows process 900 for determining a usage level of container 101 as shown in FIG. 1. At block 901, measuring circuit 401 or 501 generates an excitation signal to charge equivalent capacitor 402 or 502, respectively.

At block 902, measuring circuit 401 or 501 measures the charge or voltage across equivalent capacitor 402 or 502 at a measuring time Tₘ after charging or while the capacitor is charging or discharging. At block 903 processing circuit 703 then compares the measured voltage with predetermined voltage ranges to determine whether the corresponding capacitance is indicative of the usage level being above or below the point level of the electrode pair.

When the usage level is below the point level, block 904 determines whether the point level corresponds to an alert level. If so, apparatus 700 generates an alert notification at block 905 to inform a user about the situation via a reporting circuit (for example, wireless communication circuit 704 as shown in FIG. 7). For example, apparatus 700 may automatically order container contents by generating an order request to a distributor via the Internet on behalf of the user. With some embodiments, the ordering process may be transparent to the user.

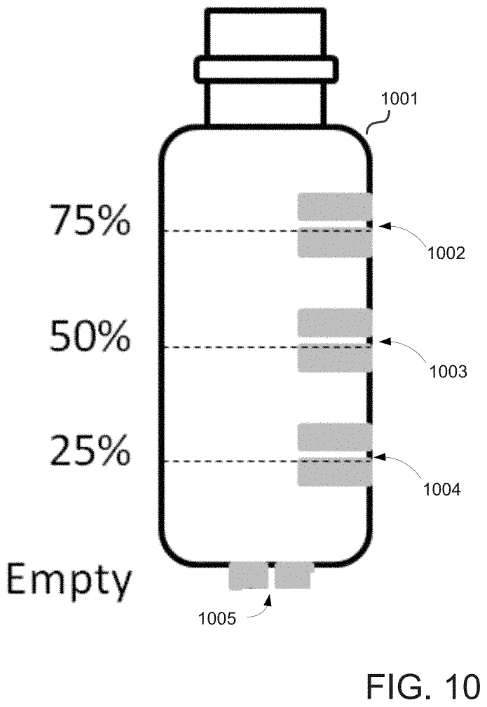

FIG. 10 shows container 1001 with a plurality of sense electrode pairs 1002-1005 for determining a usage level of the container contents. Each electrode pair 1002-1005 has an associated point level (for example, 75%, 50%, 25%, and Empty) similar to point level 151 as shown in FIG. 1.

As will be discussed, each electrode pair 1002-1005 may be selectively connected to a measuring circuit to obtain measurements indicative of the equivalent capacitance of the selected electrode pair.

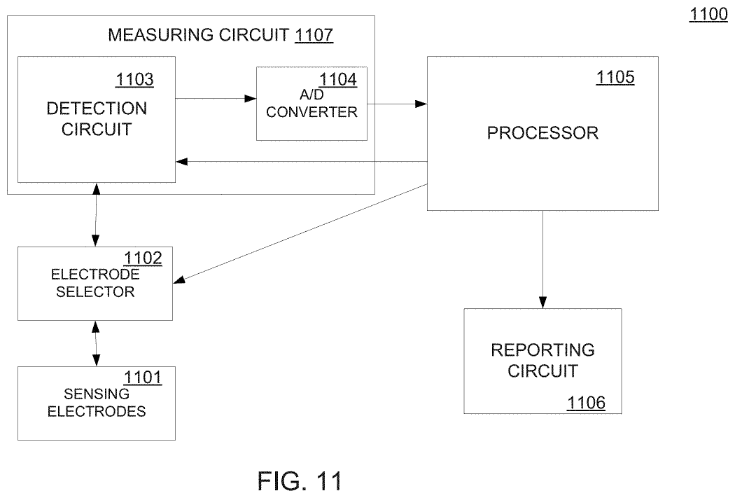

FIG. 11 shows apparatus 1100 for determining a usage level of container 1001 as shown in FIG. 10. Apparatus comprises sensing electrodes 1101, electrode selector 1102, measuring circuit 1107, processor 1105, and reporting circuit 1106.

Sensing electrodes 1101 comprises electrode pairs 1002-1005 (as shown in FIG. 10).

Measuring circuit 1107 is electrically connected to a selected electrode pair via electrode selector 1102 (as configured by processor 1105) so that the selected electrode pair can be charged and measured as previously discussed with FIGS. 6A-E and 7. Electrode sensor 1102 may assume different forms including an analog multiplexer or electrical switch.

Measuring circuit 1107 may further comprise detection circuit 1103 and A/D converter 1104. Detection circuit 1103 includes a signal generator that charges the equivalent capacitor of the selected electrode pair and a signal interface that presents the discharging waveform to A/D converter 1104. A/D converter 1104 captures the charge or voltage level at the appropriate measurement time (Tₘ) and presents the value in a digital format to processor 1105.

Based on the measured capacitance from measuring circuit 1107, processor 1105 determines whether the usage level is above or below the point level of the selected electrode pair. If the usage level is below the point level, processor 1105 may select the next electrode pair physically below the previous electrode pair and initiate another measurement. This may be repeated until the lowest positioned electrode pair (for example, pair 1005 as shown in FIG. 10) is reached.

If processor 1105 determines that the usage level is below an alert level, processor 1105 may initiate an alert notification and/or ordering request via reporting circuit 1106.

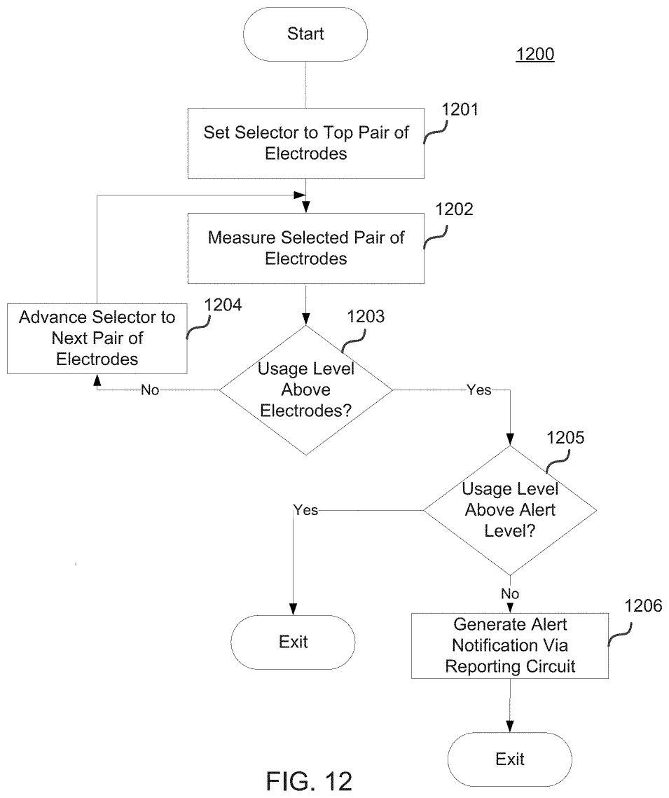

FIG. 12 shows process 1200 for determining a usage level of container 1001 by processor 1105 as shown in FIG. 11. At block 1201, process 1200 selects the top positioned electrode pair (for example, pair 1002 as shown in FIG. 10) and measures the charge or voltage of the equivalent capacitance at block 1202. Based on the measured capacitance, process 1200 determines whether the usage level is above the corresponding point level at block 1203.

If so, at block 1205 process 1200 determines whether the usage level is above the alert level. If not, process 1200 generates an alert notification at block 1206.

Referring back to block 1203, if process 1200 determines that the usage level is below the corresponding point level, process 1200 selects the next electrode pair physically below the previous electrode pair at block 1204. A measurement is then repeated for the next selected electrode pair at block 1202.

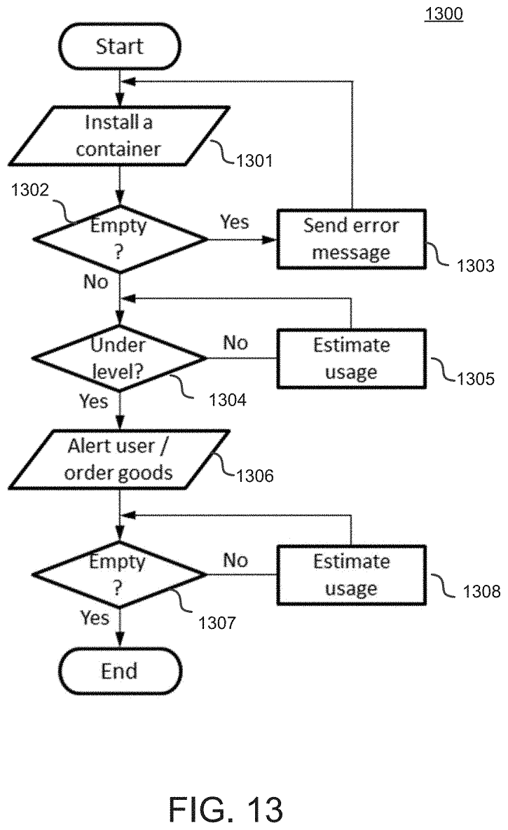

FIG. 13 shows process 1300, which may be performed by process 1105, for installing container 1001, monitoring contents of the container 1001, and alerting a user as necessary.

At block 1301, container 1001 is installed by positioning container 1001 with monitoring apparatus such as apparatus 1100. For example, when electrode pairs 1002-1005 are not located on container 1001, the electrode pairs may be positioned within a desired distance from container 1001.

At block 1302, the monitoring apparatus (for example, apparatus 1100) determines whether container 1001 is empty (for example, based on measurements provided by electrode pair 1005). If so, an error message (notification) may be sent to a user at block 1303 (for example, via reporting circuit 1106 through a mobile app executing on the user's mobile device).

If container 1001 is not empty, process 1300 continues to determine whether the container contents is below an alert level (for example, 25% as shown in FIG. 10) at block 1304. If not, process 1300 determines the usage level at block 1305 (for example, whether the usage level is above or below 50% or 75%). If the container contents is under level (for example, an alert level corresponding to 25%), process 1200 initiates an alert notification and/or a goods order at block 1306. The alert notification may include information about the contents status as determined at blocks 1307 and 1308.

Exemplary Embodiments include:

With a first exemplary embodiment, an assembly determines a level of contents within a non-metallic container. The assembly includes a capacitive sensor having at least one pair of electrodes that is positioned on or close to the surface of the container.

With a second exemplary embodiment, a capacitive sensor has one or more pairs of electrodes that are arranged to form one or more capacitors.

With a third exemplary embodiment, an assembly with a capacitive sensor detects a presence or absence of liquid or granular solids within a container at one or more predetermined levels within the container.

With a fourth exemplary embodiment, an assembly with a capacitive sensor generates an alert signal to a user.

With a fifth exemplary embodiment, an assembly comprises a microcontroller, wherein the microcontroller receives a first signal from a capacitive sensor. The first signal is indicative of a detected presence or absence of liquid or granular solids at a point level. The assembly may then generate a second signal to alert a user or to order physical goods.

Various aspects described herein may be embodied as a method, an apparatus, or as computer-executable instructions stored on one or more non-transitory and/or tangible computer-readable media. Accordingly, those aspects may take the form of an entirely hardware embodiment, an entirely software embodiment (which may or may not include firmware) stored on one or more non-transitory and/or tangible computer-readable media, or an embodiment combining software and hardware aspects. Any and/or all of the method steps described herein may be embodied in computer-executable instructions stored on a computer-readable medium, such as a non-transitory and/or tangible computer readable medium and/or a computer readable storage medium. Additionally or alternatively, any and/or all of the method steps described herein may be embodied in computer-readable instructions stored in the memory and/or other non-transitory and/or tangible storage medium of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

1. An apparatus for determining a usage level of container contents in a non-metallic container, the apparatus comprising:
a capacitive sensor comprising a plurality of electrode pairs, the plurality including a first pair of electrodes and a second pair of electrodes, wherein the first pair of electrodes comprises a first electrode and a second electrode, wherein the first pair of electrodes is externally positioned on or proximate to a surface of the non-metallic container at a first point level, wherein the second pair of electrodes is externally positioned on or proximate to the surface of the non-metallic container at a second point level, and wherein the second pair of electrodes is located below the first pair of electrodes;
a measurement circuit comprising a signal generator and a signal receiver, wherein the signal generator is configured to provide a first excitation signal to the capacitive sensor and wherein the signal receiver is configured to receive a first response signal from the capacitive sensor in response to the first excitation signal;
a processing circuit configured to initiate the measurement circuit to generate the first excitation signal, configured to measure a first measurement capacitance of the first response signal at a measurement time, and configured to determine whether the usage level of the container contents is below the first point level based on the first measurement capacitance;
an electrode selector configured to establish electrical connectivity to one of the plurality of electrode pairs with the measurement circuit;
when the determined usage level is below the first point level, the processing circuit is configured to instruct the electrode selector to establish electrical connectivity between the second pair of electrodes and the measurement circuit, to initiate the measurement circuit to generate a second excitation signal, to measure a second measurement capacitance of a second response signal at a measurement time, to determine whether the usage level of the container contents is below the second point level based on the second measurement capacitance; and
the measurement circuit, the electrode selector, and the processing circuit are configured to repeat the providing, the receiving, establishing, the instructing, the initiating, the measuring, and the determining until the usage level is above a selected pair of electrodes, wherein the selected pair of electrodes is located below the first and second pairs of electrodes.

2. (canceled)

3. (canceled)

4. (canceled)

5. (canceled)

6. The apparatus of claim 1 further comprising:
a reporting circuit; and
the processing circuit configured to initiate an alert notification through the reporting circuit when the usage level is below the first point level and to estimate usage of the container contents when the usage level is above the first point level.

7. The apparatus of claim 1 wherein the container contents comprises a first substance and the processing circuit determines that the usage level is below the first point level when the first measurement capacitance is within a second measurement range.

8. The apparatus of claim 7, wherein the container contents comprises a second substance and the processing circuit determines that the usage level is below the first point level when the first measurement capacitance is within a third measurement range, wherein the first and second substances are different.

9. The apparatus of claim 1 further comprising an electrical switch, wherein the second electrode is electrically connected to an electrical ground and wherein the electrical switch is configured to electrically connect one of the signal generator and the signal receiver with the second electrode.

10. The apparatus of claim 1 wherein the signal generator is electrically connected to the first electrode and the signal receiver is electrically connected to the second electrode.

11. The apparatus of claim 1, wherein the capacitive sensor comprises M electrode pairs positioned in decreasing point positions along the non-metallic container and wherein the processing circuit is configured to select a next electrode pair through the electrode selector until the usage level is below an associated point position of the selected electrode pair.

12. A method for determining a usage level of container contents in a non-metallic container, the method comprising:
externally positioning a first pair of electrodes on or proximate to a surface of the non-metallic container at a first point level, wherein the first pair of electrodes comprises a first electrode and a second electrode;
generating a first excitation signal and presenting the first excitation signal to the first pair of electrodes;
receiving, in response to the generating and the presenting, a first response signal from the first pair of electrodes;
measuring a first measurement capacitance of the first response signal at a measurement time;
determining whether the usage level of the container contents is below the first point level based on the first measurement capacitance;
externally positioning a second pair of electrodes on or proximate to a surface of the non-metallic container at a second point level;
when the determined usage level is below the first point level, advancing electrical connectivity to the second pair of electrodes, wherein the second pair of electrodes is located below the first pair of electrodes;
generating a second excitation signal and presenting the second excitation signal to the second pair of electrodes;
in response to the generating and the presenting the second excitation signal, obtaining a second response signal from the second pair of electrodes;
measuring a second measurement capacitance of the second response signal at the measurement time;
determining whether the usage level of the container contents is below the second point level based on the second measurement capacitance; and
repeating the generating, the obtaining, and the measuring until the usage level is above a selected pair of electrodes, wherein the selected pair of electrodes is located below the first and second pairs of electrodes.

13. The method of claim 12, wherein the determining further comprises:
determining that the usage level is below the first point level when the first measurement capacitance is within a first capacitance range.

14. (canceled)

15. The method of claim 12, comprising:
initiating an alert notification when the usage level is below the first point level; and
estimating usage of the container contents when the usage level is above the first point level.

16. The method of claim 12, wherein the measuring occurs when the first pair of electrodes are charging.

17. The method of claim 12, wherein the measuring occurs when the first pair of electrodes are discharging.

18. One or more non-transitory computer-readable media storing instructions that, when executed by an apparatus comprising at least one processor, a memory, and a capacitive sensor, cause the apparatus to:
generate a first excitation signal and present the first excitation signal to a first pair of electrodes, wherein the capacitive sensor comprises the first pair of electrodes and wherein the first pair of electrodes is externally positioned on or proximate to a surface of a non-metallic container at a first point level, wherein a second pair of electrodes is externally positioned on or proximate to the surface of the non-metallic container at a second point level, and wherein the second pair of electrodes is located below the first pair of electrodes;
receive, in response to the generating and the presenting, a first response signal from the first pair of electrodes;
measure a first measurement capacitance of the first response signal at a measurement time; and
determine whether a usage level of container contents in the non-metallic container is below the first point level based on the first measurement capacitance;
when the determined usage level is below the first point level, advance electrical connectivity to the second pair of electrodes, wherein the second pair of electrodes is located below the first pair of electrodes;
generate a second excitation signal and present the second excitation signal to the second pair of electrodes;
in response to the generating and the presenting the second excitation signal, obtain a second response signal from the second pair of electrodes;
measure a second measurement capacitance of the second response signal at the measurement time;
determine whether the usage level of the container contents is below the second point level based on the second measurement capacitance; and
repeat the generating, the obtaining, and the measuring until the usage level is above a selected pair of electrodes, wherein the selected pair of electrodes is located below the first and second pairs of electrodes.

19. (canceled)

20. The one or more non-transitory computer-readable media of claim 18 storing instructions that, when executed by the apparatus, cause the apparatus to:
initiate an alert notification when the usage level is below the first point level; and
estimate usage of the container contents when the usage level is above the first point level.
